(19) United States
(12) Patent Application Publication
(10) Pub. No.: US 2016/0156470 A1
(43) Pub. Date: Jun. 2, 2016

(54) SYSTEM FOR SHARING A CRYPTOGRAPHIC KEY

(71) Applicant: KONINKLIJKE PHILIPS N.V., Eindhoven (NL)

(72) Inventors: RONALD RIETMAN, EINDHOVEN (NL); LUDOVICUS MARINUS GERARDUS MARIA TOLHUIZEN, WAALRE (NL); DOMINGO GOMEZ, LOS CORRALES (ES); OSCAR GARCIA-MORCHON, AACHEN (DE)

(21) Appl. No.: 14/904,110

(22) PCT Filed: Jul. 3, 2014
(86) PCT No.: PCT/EP2014/064133

§ 371 Date: Jan. 11, 2016

Related U.S. Application Data
(60) Provisional application No. 61/845,391, filed on Jul. 12, 2013.

(30) Foreign Application Priority Data
Sep. 18, 2013 (EP) 13184869.9

(51) Int. Cl. H04L 9/30

(52) U.S. Cl. CPC H04L 9/3093

(57) ABSTRACT

A system (200) for configuring a network device (300) for key sharing is provided, and a first (300) and second network device configured to determine a shared key between them. The system comprises a key material obtainer (210) for obtaining in electronic form a public global reduction polynomial (216, N(t)), a first private set of bivariate polynomials (212, fi(,)), and a second private set of reduction polynomials (214, Qi(t)), with each bivariate polynomial in the first set a reduction polynomial of the second set being associated, and a polynomial manipulation unit (220) for computing a univariate private key polynomial (228) from the first and second private sets by mapping an identity number (A) of the network device to an identity polynomial, obtaining a set of univariate polynomials by for each particular polynomial of the first private set, substituting the identity polynomial (A) into said particular polynomial fi(A,) and reducing modulo the reduction polynomial associated with said particular polynomial, and summing the set of univariate polynomials, the system is configured for electronically storing the generated univariate private key polynomial (228, 236) and the public global reduction polynomial (216, N(t)) at the network device. The first network device stores the univariate private key polynomial (312) and the public global reduction polynomial (314, N(t)) and its identity number (310, A). The first network device derives a shared key from mapping the identity number of a second network device to an identity polynomial, substituting the identity polynomial into the univariate private key polynomial and reducing the result of the substituting modulo the public global reduction polynomial (N(t)).

### FIELD OF THE INVENTION

The invention relates to a system for configuring a network device for key sharing, the system comprising: a key material obtainer for obtaining a polynomial, a network device manager for obtaining in electronic form an identity number for the network device, and a polynomial manipulation unit.

### BACKGROUND

In cryptography, a key-agreement protocol is a protocol whereby two or more parties that may not yet share a common key can agree on such a key. Preferably, both parties can influence the outcome so that neither party can force the choice of key. An attacker who eavesdrops on all communication between the two parties should learn nothing about the key. Yet, while the attacker who sees the same communication learns nothing or little, the parties themselves can derive a shared key.

Key agreement protocols are useful, e.g., to secure communication, e.g., to encrypt and/or authenticate messages between the parties.

Practical key agreements protocols were introduced in 1976 when Whitfield Diffie and Martin Hellman introduced the notion of public-key cryptography. They proposed a system for key agreement between two parties which makes use of the apparent difficulty of computing logarithms over a finite field GF(q) with q elements. Using the system, two users can agree on a symmetric key. The symmetric key may then be used for say, encrypted communication between the two parties.

The Diffie-Hellman system for key agreement is applicable when the parties do not yet have a shared secret. The Diffie-Hellman key agreement method requires resource-heavy mathematical operations, such as performing exponentiation operations over a finite field. Both the exponent and the field size may be large. This makes key agreement protocols less suitable for low-resource devices. On the other hand key agreement protocols would be very useful in resource-restrained devices. For example, in application areas such as the internet of things, ad-hoc wireless networks, and the like, key agreement could be used to protect links between devices. Another example is communication between a reader and an electronic tag, say a card reader and a smart card, or a tag reader and tag, e.g., an RFID tag or an NFC tag.

Another approach to the problem of setting up secure connections between pairs of network devices in a given communications network is given in C. Blundo, A. De Santis, A. Herzberg, S. Kutten, U. Vaccaro and M. Yung, “Perfectly-Secure Key distribution for Dynamic Conferences”, Springer Lecture Notes in Mathematics, Vol. 740, pp. 471-486, 1993 (referred to as ‘Blundo’).

This system assumes a central authority, also referred to as the network authority or as the Trusted Third Party (TTP), that generates a symmetric bivariate polynomial f(x,y), with coefficients in the finite field F with p elements, wherein p is a prime number or a power of a prime number. Each device has an identity number in F and is provided with local key material by the TTP. For a device with identifier η, the local key material is the coefficients of the polynomial f(η,y). If a device η wishes to communicate with device η′, it uses its key material to generate the key K(η, η′)=f(η, η′). As f is symmetric, the same key is generated. The local key material is secret. Knowledge of the local key material would directly compromise the system. In particular it would allow an eavesdropper to obtain the same shared key. The method requires that each device in a network of devices has its own unique identity number and local key material.

A problem of this key sharing scheme occurs if an attacker knows the key material of t+1 or more devices, wherein t is the degree of the bivariate polynomial. The attacker can then reconstruct the polynomial f(x,y). At that moment the security of the system is completely broken. Given the identity numbers of any two devices, the attacker can reconstruct the key shared between this pair of devices.

Reference is made to US patent application 2011/206201 A1 with title “Method Of Generating A Cryptographic Key, Network And Computer Program Therefor”. Reference is made to the paper “A Permutation-Based Multi-Polynomial Scheme for Pairwise Key Establishment in Sensor Networks”, by Song Guo, et al.

### SUMMARY OF THE INVENTION

It would be advantageous to have an improved system for key distribution and key sharing between network devices, especially low-resource network devices.

A system for configuring a network device for key sharing is provided. The system comprises a key material obtainer, a network device manager and a polynomial manipulation unit.

The key material obtainer is configured to obtain in electronic form a public global reduction polynomial, a first private set of bivariate polynomials, and a second private set of reduction polynomials. Each bivariate polynomial in the first set is associated with a reduction polynomial of the second set.

The network device manager is configured to obtain in electronic form an identity number for the network device.

The polynomial manipulation unit is configured to compute a univariate private key polynomial from the first and second private sets by mapping the identity number to an identity polynomial obtaining a set of univariate polynomials by for each particular polynomial of the first private set, substituting the identity polynomial into said particular polynomial and reducing modulo the reduction polynomial associated with said particular polynomial, and summing the set of univariate polynomials.

The network manager is further configured for electronically storing the generated univariate private key polynomial and the public global reduction polynomial at the network device.

When the system has configured at least two network devices for key sharing, e.g., a first and a second network device, then the two network devices can agree on a symmetric shared key.

A first network device is provided configured to determine a shared key with a second network device. The first network device comprises electronic storage, a communication unit, a polynomial manipulation unit, and a key derivation device.

The electronic storage stores a univariate private key polynomial and a public global reduction polynomial obtained from a system for configuring a network device for key sharing. The storage also stores an identity number for the first network device.

The communication unit is configured to obtain an identity number of the second network device, the second network device being different from the first network device.

The polynomial manipulation unit is configured to map the identity number of the second network device to an identity polynomial, to substitute the identity polynomial into the univariate private key polynomial and to reduce the result of the substituting modulo the public global reduction polynomial.

The key derivation device is configured to derive the shared key from the result of the reduction modulo the public global reduction polynomial.

A system for key sharing system comprises a system for configuring a network device for key sharing and a first and second network device configured by the system for configuring a network device for key sharing.

Any pair of two network devices out of multiple network devices that each have an identity number and univariate private key polynomial generated for their identity number are able to negotiate a shared key with few resources. The two network devices need only exchange their identity numbers, which need not be kept secret, and perform polynomial computations. The type of computations needed do not require large computational resources, which means that this method is suitable for low-cost high volume type of applications. Although the current system may use finite fields for the coefficients of some polynomials, e.g., the reduction polynomials, these may be chosen comparatively small, even as small as 2.

The univariate private key polynomial is obtained by adding polynomials that are evaluated over different polynomial rings. As a result the relationship between the univariate private key polynomial and the root key material, i.e., the first and second private set is disturbed. An attacker who has access to one or more univariate private key polynomials still cannot obtain the first and second private set. This means that the system is secure against collusions of network devices.

Furthermore, even with access to shared keys that have been derived, it is hard to find the local key material of other devices.

The coefficient of the reduction polynomials in the second private set as well as the global reduction polynomial have integer coefficients, e.g., taken from a finite commutative ring with p elements, or a finite field F, in which case p is a prime number or a power of a prime number. The coefficients of the bivariate polynomials in the first private set, the univariate polynomials and the private key univariate polynomials have coefficients taken from a polynomial ring defined by a reduction polynomial.

Surprisingly, even though computations over different polynomials rings are mixed, two network devices are still able to obtain the same shared key together.

In an embodiment, the binary representation of the identity number has at least as many bits as the binary representation of the shared key. If larger keys are needed the system can be performed multiple times to obtain univariate private key polynomials and thus multiple shared keys. The multiple shared keys can then be combined, say concatenated, to create larger keys. In an embodiment in which multiple shared keys are combined to created a larger shared key, the identity numbers are preferably larger than the shared keys. For example, the identity number may be 8 times larger or more. In an embodiment, the network device has one or more identity numbers, and multiple univariate private key polynomials. Each of univariate private key polynomial is generated for one of the one or more identity numbers. As an example, the shared keys may be 16 bits whereas the one or more identity numbers are 128 bits. By concatenating multiple shared keys an appropriate key length may be obtained, e.g., 8 shared keys of 16 bits toegether give a 128 bit shared key. Attacks, especially lattice attacks, are much harder if the number of key bits obtained is smaller than the number of bits in the identity number; thus by combining mutliple shared small keys, each obtained from a larger identity number, into one shared large key, security is increased.

Because the derivation of the univariate private key polynomial uses reduction polynomials which are different from the public global reduction polynomial, the mathematical relationship that would be present when working, say, in a single finite field is disturbed. This means that the usual mathematical tools for analyzing polynomials, e.g., finite algebra, no longer apply. At best an attacker may use much less efficient structures, such as lattices. The method allows direct pair wise-key generation and is resilient to the capture of a very high number, e.g. in the order of 10̂5 or even higher, of network devices.

Each reduction polynomial Qᵢ(t) defines a polynomial ring, e.g., Z[t]/Qᵢ(t). Thus with each polynomial of the first private set of bivariate polynomials a commutative ring is associated. In most embodiments the polynomial rings are defined over a finite integer ring, Zₚ[t]/Qᵢ(t), for some positive integer p. Typically, this modulus integer p will be the same for all polynomials in the second set, however, it is possible to define a third set of moduli pᵢ, so that with each reduction polynomial in the second set a reduction modulus in the third set is associated. The univariate polynomials obtained from substituting the identity polynomials are also reduced modulo the modulus integer p or the associated modulus integer pᵢ, as the case may be. The key material obtained may be configured to obtain the modulus integer, e.g., by generation or from an external source.

Summing the set of univariate polynomials is done in a global ring. This global ring may be simply Z[x] (or Z[y]), however the global ring may also be, e.g., Z [t]/N(t) or Zₚ[t]/N(t). The number p may be public, and stored at each network device.

In an embodiment, the system comprises an electronic random number generator and the key material obtainer is configured to generate one or more coefficients of the public global reduction polynomial using the electronic random number generator.

In an embodiment, the system comprises an electronic random number generator and the key material obtainer is configured to generate one or more coefficients of a bivariate polynomial in the first private set using the electronic random number generator.

In an embodiment, the system comprises an electronic random number generator and the key material obtainer is configured to generate one or more coefficients of a reduction polynomial in the second private set using the electronic random number generator.

Random generation is likely to produce hard instances of the underlying problem. The underlying problem is related to the so-called ‘hidden number problem’. In problems of this kind an adversary obtains (partial) evaluation of computations based on secret information. The adversary is then tasked with reconstructing the secret information.

In an embodiment of the system for key sharing all polynomials in the first private set are symmetric bivariate polynomials. In such a system, any device can derive a shared key with any other device.

In an embodiment of the system for configuring a network device for key sharing the first private set of bivariate polynomials comprises at least two different bivariate polynomials. Preferably, the reduction polynomials associated with the at least two polynomials are different. Having at least two polynomials in the first private set, with different associated reduction polynomials are requirements for the so-called mixing effect over multiple different rings.

In an embodiment of the system for configuring a network device for key sharing at least one polynomial of the first private set has a degree of at least two in one of the two variables of said at least one polynomial. Although having one, or even all polynomials in the first set of degree one does not directly lead to an easy instance, however the underlying hard problem reduces to the classic hidden number problem, instead of a polynomial version thereof. The polynomial version of the hidden number problem is considerably harder and thus preferred to base a cryptographic system on.

In an embodiment, the first set has at least two polynomials of at least degree two with different associated reduction polynomials.

The degree of the public global reduction polynomial is a security parameter. In an embodiment, the degree of the public global reduction polynomial is larger than the size of the shared key in bits for which the network devices are configured. The degree of the public global reduction polynomial may be even larger, say larger than twice the size of the shared key in bits.

In an embodiment of the system for configuring a network device for key sharing, the univariate private key polynomial is represented as a list of coefficients and in a canonical form.

In an embodiment of the system for configuring a network device for key sharing, the result of substituting the identity polynomial into said particular polynomial and reducing modulo the reduction polynomial associated with said particular polynomial is represented as a list of coefficients and in a canonical form before the summing.

In an embodiment of the system for configuring a network device for key sharing, the polynomial manipulation unit is configured to reduce the result of summing the set of univariate polynomials modulo the public global reduction polynomial. Because the network device operates in the ring defined by the global reduction polynomial, it will not make a difference for the derived shared key if this step is performed or not. However, this additional step may remove possible observable remnants in the univariate private key polynomial of the secret information in the first and second private set.

Before the substitutions the identity number must be seen as an element of a ring defined by the appropriate ring defined by a reduction polynomial. This step could be done in a number of ways. However, one of the most easy to do this is to write the identity number in a number system with the same base used to define the polynomials in the first and second set. In an embodiment, that base is 2, this means that the identity number may be taken as a bit string and these bit strings. On most modern computers this does not require additional conversions. Avoiding conversion is also possible if the base number is a power of two. However, if the base number is not 2 or a power thereof, then conversion may be needed.

In an embodiment of the system for configuring a network device for key sharing, mapping the identity number to an identity polynomial comprises mapping the identity number by assigning the digits of the converted identity number as the coefficient of the identity polynomial.

In an embodiment of the system for configuring a network device for key sharing, mapping the identity number to an identity polynomial comprises converting the identity number from a binary number into a number with a base-number different from 2, and mapping the identity number by assigning the digits of the converted identity number as the coefficient of the identity polynomial.

The mixing effect is least for the low degree monomials. If an attacker is able to find obtain the key material for many devices for which the identity polynomials are close, i.e., the difference between the identity polynomials occurs mainly in monomials of low degree, then he may be able reconstruct key material of other devices with close identity polynomials. Therefore, a potential weakness of the system, especially for smaller configurations, could be related to the generation of identity numbers. It should be stressed that this particular weakness has not materialized, and no attacks of this type are known for the system described herein. Nevertheless, there are several ways to increase security by reducing this attack vector.

In an embodiment of the system for configuring a network device for key sharing, mapping the identity number (A) to an identity polynomial comprises hashing the identity number and converting the result of the hashing to at least part of the identity polynomial, e.g., by assigning digits of the result of the hashing, possibly mapped to a different number base, to coefficients of the identity polynomial. For example, an identity number of b bits may be hashed and concatenated to b bits. This spreads the identity numbers over the whole range of potential identity numbers and makes is prohibitively hard to find two devices with particular requirements on their identity numbers, e.g., that they are close.

To make this even more secure, identity numbers may be extended to more bits. For example, an identity number of b′ bits may hashed and concatenated to b bits, with b′<b. After the hashing operation the usual mapping to an identity polynomial may be done, e.g., by assigning digits to coefficients.

In an embodiment of the system for configuring a network device for key sharing, mapping the identity number (A) to an identity polynomial comprises extending the identity number, e.g., by hashing the identity number and concatenating at least part of the result of the hasing to the least significant end of the identity number.

In an embodiment of the system for configuring a network device for key sharing, the network device manager obtains an identity number for the network device by generating at least part of the identity number. In this embodiment, whole or part of the identity number is generated by the system and stored at the network node. Generating an identity number may be done by generating a random string of b′ bits. Generating an identity number may be done by appending a random string of bits after a smaller identity number. For example, the network device may receive an identity number of the network node and append a number, say 10, random bits, and store the result as identity number on the network node.

For the hash function, a cryptographic hash may be used, such as Sha-256, Ripemd-256, and the like.

In an embodiment of the system for configuring a network device for key sharing, the key material obtainer is configured to generate a common polynomial, and generate the reduction polynomials as the difference between the public global reduction polynomial and a multiple of the common polynomial. In an embodiment, the network manager is further configured for electronically storing the common polynomial at the network device.

In an embodiment of the system for configuring a network device for key sharing, the multiple of the common polynomial has degree less than or equal to M−α(b−1), wherein M is the degree of the public global reduction polynomial, a is the highest degree of a polynomial in the first private set of bivariate polynomials, and b is the number of bits of the identity numbers. This restriction on the degree ensures that both parties compute the same shared key. In an embodiment, the multiple of the common polynomial has degree less than or equal to M−α(b−1) for each reduction polynomial.

In an embodiment of the system for configuring a network device for key sharing, at least one multiple of the common polynomial has degree higher than M−2α(b−1). This restriction ensures that the mixing effect is obtained, this increases security.

In an embodiment of the first network device, the electronic storage stores a univariate private key polynomial, a public global reduction polynomial, and a common polynomial. The polynomial manipulation unit is further configured for further reducing the result of the reducing modulo the public global reduction polynomial modulo the common polynomial. Reducing modulo the common polynomial is one way to reduce the size of the shared key to the appropriate length. Both parties derive the same shared key if the reduce modulo the common polynomial.

An aspect of the invention concerns a method for configuring a network device for key sharing. An aspect of the invention concerns a method for determining a shared key with a second network device.

In an embodiment, the first network device comprises a cryptographic unit configured to use the shared key. In an embodiment, the cryptographic unit comprises an encryption unit configured for encrypting an electronic message with the shared symmetric key. In an embodiment, the cryptographic unit comprises a decryption unit configured for decrypting an encrypted electronic message with the shared symmetric key.

The network device, e.g., the first or second network device and the configuring device are electronic devices, e.g., a set-top box, a computer, and the like. The network device, e.g., the first or second network device may be a mobile electronic device, e.g., a mobile phone.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code means stored on a computer readable medium for performing a method according to the invention when said program product is executed on a computer

In a preferred embodiment, the computer program comprises computer program code means adapted to perform all the steps of a method according to the invention when the computer program is run on a computer. Preferably, the computer program is embodied on a computer readable medium.

A system for configuring a network device for key sharing is provided, and a first and second network device configured to determine a shared key between them. The system comprises a key material obtainer for obtaining in electronic form a public global reduction polynomial N(t), a first private set of bivariate polynomials fᵢ(,), and a second private set of reduction polynomials Qᵢ(t), with each bivariate polynomial in the first set a reduction polynomial of the second set being associated, and a polynomial manipulation unit for computing a univariate private key polynomial from the first and second private sets by mapping an identity number A of the network device to an identity polynomial, obtaining a set of univariate polynomials by for each particular polynomial of the first private set, substituting the identity polynomial into said particular polynomial fᵢ(A,) and reducing modulo the reduction polynomial associated with said particular polynomial, and summing the set of univariate polynomials, the system is configured for electronically storing the generated univariate private key polynomial and the public global reduction polynomial N(t) at the network device. The first network device stores the univariate private key polynomial and the public global reduction polynomial N(t) and its identity number A. The first network device derives a shared key from mapping the identity number of a second network device to an identity polynomial, substituting the identity polynomial into the univariate private key polynomial and reducing the result of the substituting modulo the public global reduction polynomial N(t).

### BRIEF DESCRIPTION OF THE DRAWINGS

These and other aspects of the invention are apparent from and will be elucidated with reference to the embodiments described hereinafter. In the drawings,

FIG. 1 is a schematic block diagram of a system 200 for configuring a network device for key sharing and a first network device 300;

FIG. 2 is a schematic block diagram of a first network device 300 and a second network device 350;

FIG. 3a is a schematic block diagram of a key sharing system 100

FIG. 3b is a schematic block diagram of a key sharing system 102

FIG. 4 is schematic block diagram of an integrated circuit 400,

FIG. 5 is a flowchart illustrating a method 500 for configuring a network device 300, for key sharing.

FIG. 6 show a flowchart illustrating a method 600 determining a shared key with a second network device 350.

It should be noted that items which have the same reference numbers in different Figures, have the same structural features and the same functions, or are the same signals. Where the function and/or structure of such an item has been explained, there is no necessity for repeated explanation thereof in the detailed description.

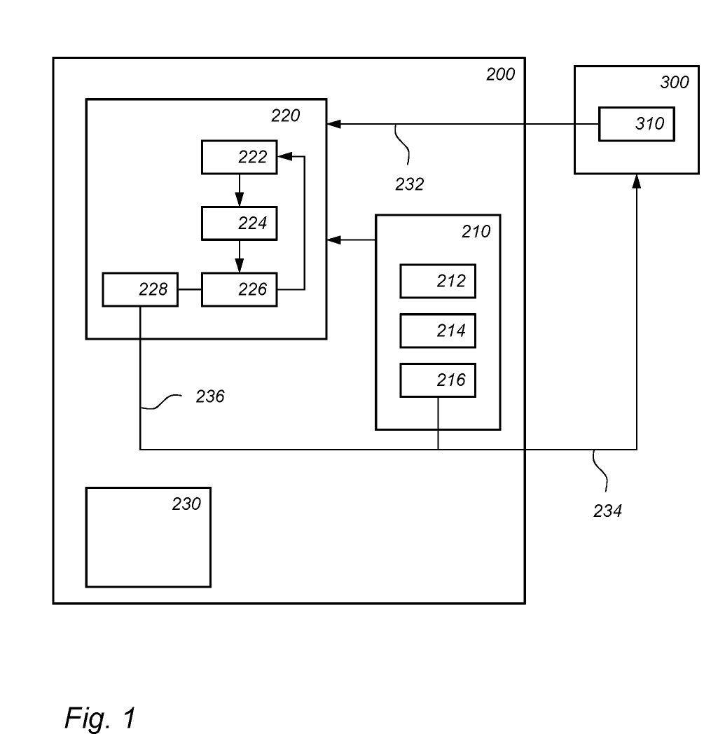

### LIST OF REFERENCE NUMERALS IN FIGS. 1-4

100 a key sharing system
110 a personalization device
200 a system for configuring a network device for key sharing
210 a key material obtainer
212 a first private set of bivariate polynomials
214 a second private set of reduction polynomials
216 a public global reduction polynomial
220 a polynomial manipulation unit
222 a substituting unit
224 a polynomial reduction unit
226 a polynomial addition unit
228 sum of a set of univariate polynomials
230 a network device manager
232 an identity number message
234 a public global reduction polynomial message
236 a univariate private key polynomial message
300 a first network device
310 an identity number
312 a univariate private key polynomial
314 a public global reduction polynomial
320 an electronic storage
330 a polynomial manipulation unit
332 a substituting unit
334 a polynomial reduction unit
340 a key derivation device
342 a communication unit
345 a cryptographic unit
350 a second network device
355 an identity number
360 a third network device
400 an integrated circuit
410 a bus
420 a processor
430 a memory
440 an I/O unit
450 a polynomial manipulation unit

### DETAILED DESCRIPTION OF EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

FIG. 1 is a schematic block diagram of a system 200 for configuring a network device for key sharing and a first network device 300;

System for configuring 200 is typically implemented as an integrated device. For example, system for configuring 200 may be comprised in a server. System for configuring 200 may configure network devices over a network, say a wireless network, or the internet, and the like. However, system for configuring 200 may also be integrated in a manufacturing device for manufacturing the network devices.

System for configuring 200 comprises a key material obtainer 210, a network device manager 230 and a polynomial manipulation unit 220. System for configuring 200 is intended to work with multiple network devices. FIG. 1 shows one such device, first network device 300.

System for configuring 200 selects secret key material, also referred to as root key material. System for configuring 200 then derives local key material for the multiple network devices. The local key material is derived from the root key material and a public identity number A of the network device. The identity number is also referred to in formulas as η. In FIG. 1, network device 300 stores identity number 310.

The local key material comprises parts that are a private to a particular network device, i.e., only accessible to one particular network device and possibly trusted devices. The local key material may also contain parts that, though needed to obtain a shared key, are less critical to keep secret.

The use of the adjectives public and private, is intended as helpful for understanding: Even with access to all public data, the private data cannot be computed, at least not without unreasonable high resources given the security of the application or compared to the resources needed for key generation, encryption and decryption. However, ‘public’ does not mean that the corresponding data is necessarily made available to anybody else than system for configuring 200 and the network devices. In particular, keeping the public global reduction polynomial and other public parameters secret from untrusted parties increases security. Likewise, access to private data may be restricted to the party that generated or needs that data, this increases security. However, a trusted party may be allowed access to the private data; Access to private data reduces security.

Using their local key material and the identity number of the other party, the network devices can agree on a shared key between them.

Key material obtainer 210 is configured to obtain in electronic form a public global reduction polynomial (216, N(t)), a first private set of bivariate polynomials (212, fᵢ(,)), and a second private set of reduction polynomials (214, Qᵢ(t)). Each bivariate polynomial in the first set is associated with a reduction polynomial of the second set; the association is preferably a one-to-one association. Each reduction polynomial (Qᵢ and N) defines a commutative ring, i.e., by dividing a polynomial ring, e.g., as Zₚ[t]/Qᵢ.

The public global reduction polynomial 216, N(t) is different from each of the reduction polynomials 214, Qᵢ(t). Preferably, the degree of the public global reduction polynomial 216, N(t) is at least as large or larger than the degree of each of the reduction polynomials 214, Qᵢ(t).

Key material obtainer 210 does not need interaction with a network device for obtaining the key material; in particular key material obtainer 210 does not need an identity number. System for configuring 200 may be a distributed system in which key material obtainer 210 is located at a different physical location than polynomial manipulation unit 220. Key material obtainer 210 generates all or part of the key material and/or obtains all or part of the key material from an external source. For example, key material obtainer 210 is suited to receive public global reduction polynomial 216 from an external source and generate first private set 212 and second set 214. The latter allows all network devices to be manufactured with a fixed public global reduction polynomial 216, reducing cost.

Key material obtainer 210 may comprise an electronic random number generator. The random number generator may be a true or pseudo random number generator. Key material obtainer 210 may generate one or more coefficients of the public global reduction polynomial (N(t)), e.g., using the electronic random number generator. Although, the public global reduction polynomial is public information, introducing randomness makes analyzing the system more difficult.

Key material obtainer 210 may generate one or more coefficients of a bivariate polynomial (122, fᵢ(,)) in the first private set, e.g., using the electronic random number generator. Key material obtainer 210 may generate all of the bivariate polynomial in this fashion. Key material obtainer 210 may use a maximum degree of these polynomials, say 2, or 3 or higher, and generate one more random coefficient than the degree. The random coefficients may be randomly selected from an integer ring, e.g., the integers modulo a number, such as a prime number.

Key material obtainer 210 may generate one or more coefficients of a reduction polynomial (Qᵢ(t)) in the second private set using the electronic random number generator. It is not necessary that the reduction polynomials are irreducible. However, they may be chosen as irreducible to increase resistance. Irreducible polynomials give rise to fields, which is a species of rings. The same first and second private set, public global reduction number and reduction moduli are used for all network devices that later need to share a key.

It is convenient to prescribe some aspects of private set 212, such as the number of polynomials in private set 212 and the degrees of the polynomials, or the maximum degrees. It may also be prescribed that some of coefficients in the polynomials are zero, e.g., for reducing storage requirements.

The first set may contain two equal polynomials. This will work, however, unless the associated reduction polynomials are different the sets may be reduced in size. So typically, whenever two or more bivariate polynomials in the first set are the same, the associated reduction polynomials, i.e. the underlying ring, is different.

The first private set of bivariate polynomials (fᵢ(,)) only comprises symmetric bivariate polynomials. Using only symmetric polynomials has the advantage that each network device can agree on a shared key with any other network device of the configured network devices. However, the first private set of bivariate polynomials may contain one or more asymmetric polynomials; this has the effect that the devices can be portioned into two groups: a device from one group can only agree on a shared key with a device of the second group.

Key material obtainer 210 is configured to obtain in electronic form a first private set of bivariate polynomials 212, also referred to as fᵢ(,) in formulas. The embodiment described below assumes that all bivariate polynomials in set 212 are symmetric.

A symmetric bivariate polynomial may also be notated as fᵢ(x,y) with two formal variables as placeholder. A symmetric bivariate polynomial satisfies fᵢ(x,y)=fᵢ(y,x). This requirement translates to a requirement on the coefficients, e.g., that the coefficient of a monomial x^{a}y^{b} equals the coefficient of a monomial x^{b}y^{a}.

The number of polynomials in first private set 212 may be chosen differently depending on the application. The system will work when the first and second set contain only a single polynomial; in such a system keys may be successfully shared and provide a moderate level of security. However, the security advantage of mixing over different rings (explained below) is only achieved when the first and second set have at least 2 polynomials in them. Private set 212 comprises at least one bivariate polynomial. In an embodiment of initiating key-agreement device 100 the private set 212 consists of one polynomial. Having only one polynomial in private set 212 reduces complexity, storage requirements and increases speed. However, having only one polynomial in private set 212 is considered less secure than having two or more polynomials in private set 212 because such a one-polynomial system does not profit from additional mixing in the summation described below. However, key sharing will work correctly and are considered sufficiently secure for low-value and/or low-security applications.

In the remainder, we will assume that private set 212 comprises at least two symmetric bivariate polynomials. In an embodiment, at least two, or even all of the polynomials are different; this complicates analysis of the system considerably. It is not necessary though, private set 212 may comprise two equal polynomials and still benefit from mixing in the summation step if these two polynomials are evaluated over different rings; this point will be discussed further below. In an embodiment, private set 212 comprises at least two equal polynomials associated with different associated reduction polynomials. Having two or more equal polynomials in the first set reduces storage requirements. In an embodiment, the second comprises at least two polynomials, and all polynomials in the second set are different

The polynomials in private set 212 may be of different degrees. With the degree of a symmetric bivariate polynomial we will mean the degree of the polynomial in one of the two variables. For example, the degree of x²y²+2xy+1 equals 2 because the degree in x is 2. The polynomials may be chosen to have the same degree in each variable; if the polynomials in private set 212 are symmetric the degree will be the same in the other variable.

The degrees of polynomials in private set 212 may be chosen differently depending on the application. Private set 212 comprises at least one symmetric bivariate polynomial of degree 1 or higher. In an embodiment, private set 212 comprises only polynomials of degree 1. Having only linear polynomials in private set 212 reduces complexity, storage requirements and increases speed. However, having only degree one polynomials in private set 212 is considered less secure than having at least one polynomial of degree at least two in private set 212 because such a system is considerably more linear. Even so, if multiple polynomials in private set 212 are evaluated over different rings, then the resulting encryption is not linear even if all polynomials in private set 212 are. In an embodiment, private set 212 comprises at least one, preferably two, polynomials of degree 2 or higher. However, key generation, encryption and decryption will work correctly if only degree 1 polynomials are used and is considered sufficiently secure for low-value and/or low-security applications.

Having one or more polynomials in private set 212 with degree 0 will not impact the system, so long as the polynomial(s) with higher degree provide sufficient security.

For a mid-security application, private set 212 may comprise, or even consist of, two symmetric bivariate polynomials of degree 2. For a higher security application, private set 212 may comprise or even consist of two symmetric bivariate polynomials, one of degree 2 and one of degree higher than 2, say 3. Increasing the number of polynomials and/or their degrees will further increase security at the cost of increased resource consumption.

Preferably, the reduction polynomials are selected so that the difference of any two reduction polynomials has a common polynomial divisor. For example, one way to generate the reduction polynomials and the public global reduction polynomial is as follows.

First generate the public global reduction polynomial N(t), e.g., as a random polynomial of prescribed degree,

Generate a common polynomial γ(t)

For each reduction polynomial, generate a polynomial βᵢ(t), and generate the reduction polynomial (Qᵢ(t)) as the difference Qᵢ(t)=N(t)−βᵢ(t)γ(t).

The degree of the common polynomial may be chosen proportional to the desired system security, e.g., equal: For example, the degree of common polynomial γ(t) may be chosen to be equal to the number of bits in the generated shared keys. One option is to choose the degree of common polynomial γ(t) equal to b. The degree of the public global reduction polynomial is referred to as M. This degree is chosen larger than that of the common polynomial. For example, a good choice is select M as 2α(b−1)+deg(γ(t))−1, or higher. Herein, α is the highest degree of a polynomial in the first private set of bivariate polynomials, and b is the number of bits in the identity number. In an embodiment, the network manager is further configured for electronically storing the common polynomial at the network device.

Furthermore, each multiple of the common polynomial βᵢ(t)γ(t) preferably has a degree less than or equal to M−α(b−1), wherein M is the degree of the public global reduction polynomial (N(t)). To improve mixing at least one multiple of the common polynomials βᵢ(t)γ(t) has degree higher than M−2α(b−1).

For commercial grade security, the following parameters may be used. Note that these are only an example, value, higher and lower values are possible. The degree of the polynomials in the first private set may be taken as two, α=2. The identifier numbers have b bits, say b=128. The size of the generated shared keys is taken as equal to b bits, i.e. also 128 bits. Reduction polynomials are generated from a common polynomial γ of degree b, e.g. 128 bits. Taking degree M=2α(b−1)+deg(γ(t))−1, so M=635 bits. The polynomials βᵢ may be chosen randomly with degree at least zero and at most α(b−1)−1, i.e., between 0 and 253. The number of polynomials in the first private set m, is taken as 2 or higher. In general, the number of polynomials in the first set is less than 2^{α(b-1)}. A higher value of α or a lower value of deg(γ(t)) may be needed to further increase security.

Key material obtainer 210 may be programmed in software or in hardware or in a combination thereof. Key material obtainer 210 may share resources with polynomial manipulation unit 220 for polynomial manipulation.

Network device manager 230 is configured to obtain in electronic form an identity number 310, A for network device 300. Network device manager 230 may receive the identity number from the network device. For example, network device manager 230 may comprise or make use of a communication unit for receiving the identity number over a network. For example, network device manager 230 may comprise an antenna for receiving the identity number as a wireless signal. The identity number may be represented as a number of bits, typically, the number of bits in the identity number b is at least as large as the number of bits in the shared key.

Polynomial manipulation unit 220 is configured to compute univariate private key polynomial 228 from the first and second private sets and the identity number received from first network device 300. The univariate private key polynomial and the public global reduction polynomial are part of the local key material.

Polynomial manipulation unit 220 may compute the univariate private key polynomial 228 as follows. First the identity number A is converted into an identity polynomial A(t); System for configuring 200 and all of the network devices use the same mapping. If the system operates over the binary numbers, then this mapping may simply map the bits to coefficients of the identity polynomial. If the system operates over a different number system, say the integers modulo a number p, then A may be converted to a number with base p. Next the digits of the identity number written as a base-p number may be used as the coefficients of the identity polynomial. We will assume the latter mapping here for simplicity.

However, the mapping may be more complicated, for example, the mapping may first hash the identity number and concatenate, say to b bits, next a mapping as described above may be done. This ensures that the identity numbers act ‘random’ in the system. Especially if the network devices are given identity numbers according to a particular order, e.g., serial numbers, such a randomization step is advisable to ensure that lattice attacks do not simplify. If the size of the identity numbers is larger than that of the shared key, a hashing step is also advisable. Hashing steps in the mapping are not necessary. For example, if identity numbers have high entropy they may be omitted.

Other ways to decrease potential weaknesses related to non-random identity number, e.g., as part of the mapping the identity number (A) to an identity polynomial, include the following. In an embodiment, the identity number is hashed and the result converted to at least part of the identity polynomial, e.g., by assigning digits of the result of the hashing, possibly mapped to a different number base, to coefficients of the identity polynomial. For example, an identity number of b bits may be hashed and truncated to a desired number of bits, e.g. to b bits. In an embodiment of the system for configuring a network device for key sharing, mapping the identity number (A) to an identity polynomial comprises extending the identity number, e.g., by hashing the identity number and appending at least part of the result of the hasing to the least significant end of the identity number.

Furthermore, identity numbers may be extended to more bits. For example, an identity number of b′ bits may extended, e.g., by hashing and/or concatenation, to b bits, with b′<b. After the extending operation the usual mapping to an identity polynomial may be done, e.g., by assigning digits to coefficients. For example and identity number A may be mapped to H(A) or to A∥H (A); H denotes hashing and ∥ denotes concatenation. The concatenation is done at the LSB side.

Univariate polynomials are obtained by substituting the identity polynomial A(t) into each of the polynomials in the first private set. By substituting a value for only one variable of a bivariate polynomial, the bivariate polynomial reduces to a univariate polynomial. The resulting univariate polynomial is then reduced modulo the reduction polynomial associated with the bivariate polynomial in which the identity polynomial A(t) was substituted. The resulting set of univariate polynomials is summed.

Suppose fᵢ(x,y) is one of the bivariate polynomials in the first private set. The coefficients of this polynomial are taken from the ring Zₚ[t]/Qᵢ(t). That is the coefficients of the polynomials in the first set are themselves polynomials taken from a polynomial ring. Such a polynomial may be represented in memory as a three-dimensional array; two dimensions of the array represent the degrees of the monomials of fᵢ, and the third dimension represents the coefficients. For simplicity, the variables x and y are used to represent the formal variables of the polynomials in the first set, the variable t is used to represent the formal variable in the polynomial ring.

After substitution, polynomial manipulation unit 220 obtains fᵢ(A(t),y). Polynomial manipulation unit 220 is further configured to reduce this term modulo Qᵢ(t). Coefficients are reduced in the field over which the system operates, e.g., Zₚ, e.g., by reducing mod p. Preferably, polynomial manipulation unit 220 brings the result into a canonical form, i.e., a predetermined standardized representation. A suitable canonical form is representation of the coefficient sorted by degrees of the monomials. Alternatively, the substitution may be for y.

If the first set only contains symmetric polynomials, then substitution of the identity polynomial A(t) may be in either one of the two variables of the bivariate polynomial. However, if substitution is done in an asymmetric polynomial, more care is needed. For example polynomial manipulation unit 220 may be configured to obtain whether first network device 300 is in a first or second group. The first and second groups are associated with the first and second variable of the bivariate polynomials, respectively. For a network device in the first group always the first variable is used. For a network device in the second group always the second variable is used.

FIG. 1 shows one possible way to implement this function. FIG. 1 shows a substituting unit 222, a polynomial reduction unit 224, a polynomial addition unit 226 and a sum of a set of univariate polynomials 228. These may work as follows. Substituting unit 222 substitutes the identity polynomial A(t) into a bivariate polynomial of the first set. Substituting unit 222 may collect terms to bring the result in canonical form, but this may also wait. Polynomial reduction unit 224 receives the result of the substitution and reduces it modulo the reduction polynomial associated with the bivariate polynomial in which was substituted.

The result of substituting the identity polynomial A(t) into said particular polynomial fᵢ(A,) and reducing modulo the reduction polynomial associated with said particular polynomial is represented as a list of coefficients in a canonical form before the summing by polynomial addition unit 226.

Polynomial addition unit 226 receives the reduced univariate polynomials and adds them to a running total in sum 228. Sum 228 was reset to 0 prior to the generation of the univariate private key polynomial.

When all polynomials of the first private set are processed in this way, the result in sum 228 may be used as the univariate private key polynomial. The resulting univariate private key polynomial, say in sum 228, may be represented as a list of coefficients and in a canonical form.

Network device manager 230 is further configured for electronically storing the generated univariate private key polynomial 228 and the public global reduction polynomial 216, N(t) at the network device. Using the univariate private key polynomial 228 and his identity number, first network device 300 can share keys with other devices configured from the same root material.

Although polynomial manipulation unit 220 may be implemented in software, polynomial manipulation unit 220 is particularly suited for implementation in hardware, even more in particular polynomial reduction unit 224.

FIG. 1 shows polynomial manipulation unit 220 receiving an identity number message 232 from first network device 300; first network device 300 receiving a public global reduction polynomial message 234 from key material obtainer 210 and a univariate private key polynomial message 236 from polynomial manipulation unit 220. These messages typically are sent and received through network device manager 230. Univariate private key polynomial message 236 and public global reduction polynomial message 234 may be combined in a single message.

System for configuring 200 may be configured to obtain an identity number by generating an identity number for first network device 300. Such a configuration is well suited to a manufacturing facility. In that case first network device 300 receives identity number message 232 from configuration system 200, instead of sending it, say receive identity number message 232 from key material obtainer 210 or polynomial manipulation unit 220.

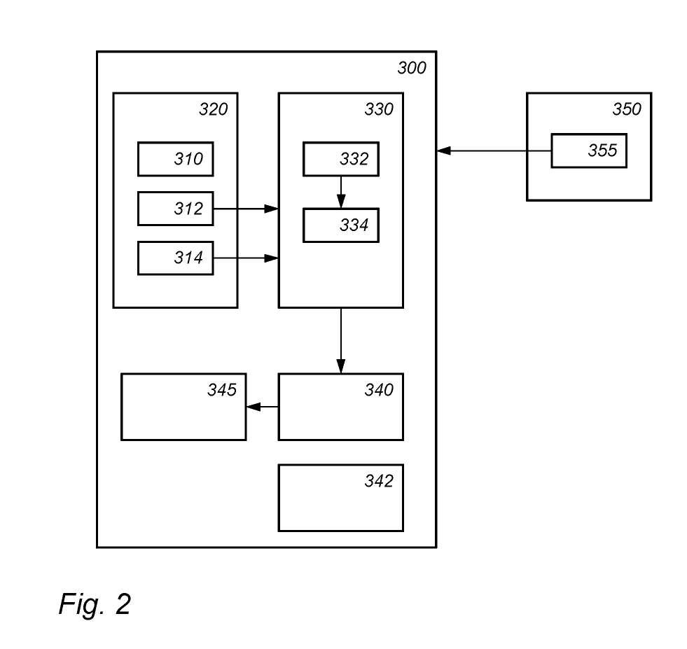

FIG. 2 is a schematic block diagram of a first network device 300 and a second network device 350. First network device 300 and second network device 350 are configured to determine a shared key together.

Second network device 350 may be of the same design as network device 300. We only describe first network device 300 in detail, second network device 350 may be the same or similar. FIG. 2 only shows that second network device 350 stores an identity number 355. The identity number 355 of second network device 350 is public and may be exchanged with network device 300 to share a key. Second network device 350 also needs local key material (not shown), in particular a univariate private key polynomial corresponding to identity number 355.

First network device 300 comprises an electronic storage 320, a communication unit 342, a polynomial manipulation unit 330 and a key derivation device 340.

Storage 320 stores the univariate private key polynomial 312 and the public global reduction polynomial 314, N(t), both obtained from a system for configuring a network device for key sharing, such as system 200. Storage 320 also stores the identity number 310, A, that was used to generate univariate private key polynomial 312. Storage 320 may be a memory, say a non-volatile and writable memory, such as flash memory. Storage 320 may be other types of storage, say magnetic storage such as a hard disk. Storage 320 may be write-once memory.

Communication unit 342 is configured to obtain an identity number 355 of second network device 350. Communication unit 342 may be implemented as a wired connection, say a Wi-Fi, Bluetooth or Zigbee connection. Communication unit 342 may be implemented with a connection over a data network, say the internet.

Polynomial manipulation unit 330 is configured to map the identity number A of the second network device to an identity polynomial A(t). First network device 300 and all of the network devices use the same mapping as was used by first network device 300. The mapping may also use the same algorithms and/or hardware. Polynomial manipulation unit 330 is configured to substitute the identity polynomial A(t) into the univariate private key polynomial and reduce the result of the substitution modulo the public global reduction polynomial (N(t)). Polynomial manipulation unit 330 may use similar hardware or software as substituting unit 222 and polynomial reduction unit 224. Note that first network device 300 does not have access to the first and second private set.

To further reduce the size of the shared key a further reduction may be done. Such a further reduction maybe needed to assure that both parties obtain the same shared key.

For example, the electronic storage 320 may further store the common polynomial γ(t). The polynomial manipulation unit 330 is further configured for further reducing the result of reducing modulo the public global reduction polynomial modulo the common polynomial. Reducing modulo the common polynomial is one way to reduce the size of the shared key to the appropriate length. Thus, the key may be calculated as follows: The network node substitutes the identity polynomial (in the formal variable t) of the other node into its private univariate polynomial and calculates the residue of the resulting polynomial (in the variable t) modulo the polynomial γ(t). The result is a polynomial of degree at most (deg(γ(t)))−1). In the binary case, the coefficients of this polynomial are concatenated to a string of deg(γ(t)) bits, the identifiers are b bits.

Key derivation device 340 is configured to derive the shared key from the result of the reduction modulo the public global reduction polynomial. The shared key is a so-called symmetric key. The resulting of the reduction is a polynomial in a polynomial ring. This result may be used almost directly as a key, say by concatenating its coefficients.

Deriving the shared key from the result of the reduction may include the application of a key derivation function, for example the function KDF, defined in the OMA DRM Specification of the Open Mobile Alliance (OMA-TS-DRM-DRM-V2_0_2-20080723-A, section 7.1.2 KDF) and similar functions.

FIG. 2 further shows an optional cryptographic unit 345 in first network device 300. Cryptographic unit 345 is configured to use the shared key. For example, cryptographic unit 345 may be an encryption unit configured for encrypting an electronic message with the shared symmetric key. For example, cryptographic unit 345 may be a decryption unit configured for decryption an electronic message with the shared symmetric key.

An important advantage to using polynomial rings is that the shared key obtained between first network device 300 and second network device 350 is always the same. With some key sharing systems, it was possible that the shared key occasionally differed between first network device 300 and second network device 350. This eventuality could be resolved through key confirmation data, but with the current system this eventuality is not a problem.

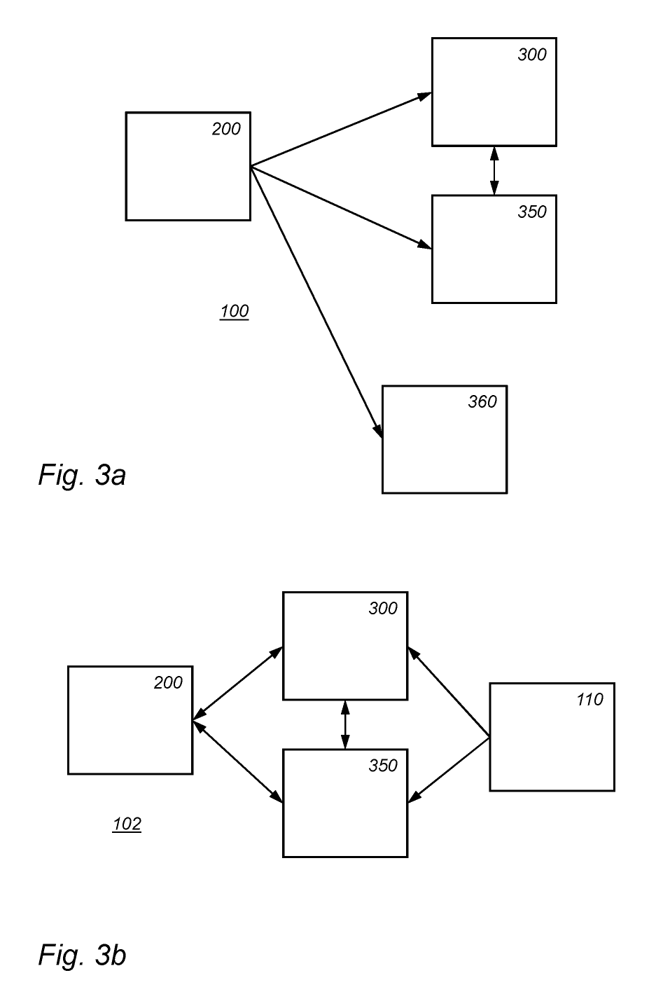

FIG. 3a is a schematic block diagram of a key sharing system 100.

Key sharing system 100 comprises system for configuring 200, and multiple network devices; shown are network device 300, 350 and 360. The network devices each receive an identity number, a univariate private key polynomial and the global reduction polynomial from system for configuring 200. Using this information they can agree on a shared key. For example, first network device 300 and second network device 350 each send their identity number to the other party. They can then compute the shared key. Someone with knowledge of the communication between first network device 300 and second network device 350 and even the global reduction polynomial cannot obtain their shared key, without using unreasonable large resources. Not even device 360 can derive the key shared between devices 300 and 350.

FIG. 3b is a schematic block diagram of a similar key sharing system 102. System 102 is the same as system 100 except that the network devices receive their identity number from a configuration server 110. The network devices then register with system for configuring 200 by sending their identity number. Note even device 260 can obtain the key shared between devices 300 and 350.

The configuration server 110 may assign an identity number that is also used for other purpososes. For example, configuration server 110 may assign a network address, such as a MAC address. The network address is used by the network node for routing network traffic from a second network node to itself However, the network address may also double as the identity number. In this case, the network node makes his network address available to system 200 and receives a univariate private key polynomial which is allows the network node to engage in encrypted communication using its network address as identity number. This is particularly conveninet since messages received by a network node typically contain a network address of the second network node, so the network can immediately reply with an encrypted response, especially, since no key confirmation step is needed.

The configuration server 110 may generate identity numbers to increase security of the system by avoiding identity numbers that are close, i.e., that share many or all of the most significant bits. For example, server 110 may generate the identity numbers randomly, say true or pseudo random. It is also sufficient to append predetermined number of random bits to an identity number, say 10 bits. The identity number may have the form A₁∥A₂, in which A₁ is not random, say a serial number, network address, or the like, and wherein A₂ is random. A₂ may be generated by a random number generator. A₂ may also be generated by hasing A₁. If a keyed hash is used, say an HMAC, this then A₂ is indistinguishable from random to parties without access to said key. The key may be generated and stored by server 110.

Server 110 may be included in system 200, e.g., incorporated in network manager 230.

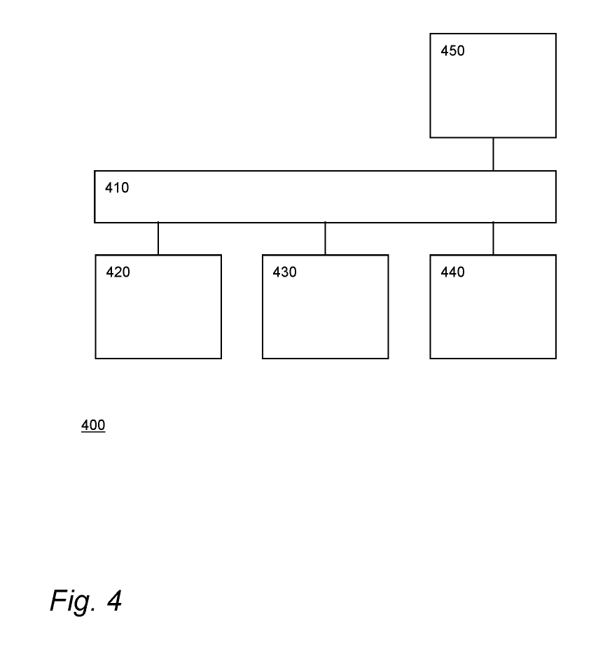

FIG. 4 is schematic block diagram of an integrated circuit 400. Integrated circuit 400 comprises a processor 420, a memory 430, and an I/O unit 440. These units of integrated circuit 400 can communicate amongst each other through an interconnect 410, such as a bus. Processor 420 is configured to execute software stored in memory 430 to execute a method as described herein. In this way integrated circuit 400 may be configured as system for configuring 200 or as a network device, such as first network device 300; Part of memory 430 may store a public global reduction polynomial, a first private set of bivariate polynomials, a second private set of reduction polynomials, an identity number, a plain message and/or encrypted message as required.

I/O unit 440 may be used to communicate with other devices such as devices 200, or 300, for example to receive key data, such as first private set of bivariate polynomials 212 and possibly associated parameters, such as sizes, degrees, moduli and the like, or to send and receive encrypted and/or authenticated messages. I/O unit 440 may comprise an antenna for wireless communication. I/O unit 440 may comprise an electric interface for wired communication.

Integrated circuit 400 may be integrated in a computer, mobile communication device, such as a mobile phone, etc. Integrated circuit 400 may also be integrated in lighting device, e.g., arranged with an LED device. For example, an integrated circuit 400 configured as a network device and arranged with lighting unit such as an LED, may receive commands encrypted with a shared symmetric key.

Multiple network devices, say incorporated in a lighting device, may form the nodes of an encrypted network, in which links are encrypted using shared keys between the nodes.

Although polynomial manipulation may be performed by processor 420 as instructed by polynomial manipulation software stored in memory 430, the tasks of key generation, and calculating the univariate polynomials are faster if integrated circuit 400 is configured with optional polynomial manipulation unit 450. In this embodiment, polynomial manipulation unit 450 is a hardware unit for executing substitution and reduction operations.

Typically, the devices 200, and 300 each comprise a microprocessor (not shown) which executes appropriate software stored at the device 200 and the 300; for example, that software may have been downloaded and/or stored in a corresponding memory, e.g., a volatile memory such as RAM or a non-volatile memory such as Flash (not shown). Alternatively, the devices 200 and 300 may, wholly or partially, be implemented in programmable logic, e.g., as field-programmable gate array (FPGA).

Below a more mathematical description is given of an embodiment of the system for key sharing.

Let R₀, R₁ . . . , Rₘ be discrete commutative rings. Let ωᵢ, 0≦i≦m be a mapping from Z to Rᵢ, and let φᵢ, 1≦i≦m, be a mapping from Rᵢ to R₀. For 1≦i≦m, let fᵢ be a function from Rᵢ×Rᵢ→Rᵢ; for simplicity we will assume all fᵢ symmetric. We consider the case that the fᵢ are polynomials of degree at most α in both variables:

$${f}_{i} ( x , y ) = {\sum }_{k = 0}^{α} {\sum }_{𝓁 = 0}^{α} {( {f}_{i} )}_{k 𝓁} {x}^{k} {y}^{𝓁} , \\ {with \\ ( {f}_{i} )}_{k 𝓁} ∈ {R}_{i}$$

$${and \\ ( {f}_{i} )}_{k 𝓁} = {( {f}_{i} )}_{𝓁 k} forallk , 𝓁 .$$

Note that here the summations and multiplications act in Rᵢ.
For η∈Z and 0≦l≦α define the key material (KM) for device η as

$${KM}_{n , 𝓁} = {\sum }_{i = 1}^{m} {φ}_{i} ( {\sum }_{k = 0}^{α} {( {f}_{i} )}_{k 𝓁} {( {ψ}_{i} ( η ) )}^{k} ) ∈ {R}_{0} ,$$

and for η,η′∈Z, the shared key material derived by device η as

$${K}_{n} ( {η}^{′} ) = {\sum }_{𝓁 = 0}^{α} {{KM}_{n , 𝓁} ( {ψ}_{0} ( {η}^{′} ) )}^{𝓁} ∈ {R}_{0} .$$

Note that the sum over k is in Rᵢ, while the sums over i and l are in the global ring R₀. Finally, let χ be a mapping from R₀ to Z, and define

κ(η,η′)=χ(Kₙ(η′))

χ may be a key derivation function. Note that even though the fᵢ are symmetric, K_{η}(η′) and K_{η′}(η) need not be equal for all choices for the rings R₀, R₁ . . . , Rₘ. The system provides a non-constant mapping χ and a subset D of the integers such that

κ(η,η′)=κ(η′,η) for all η,η′∈D,

or, if that's not possible, such that

κ(η,η′)≈κ(η′,η) for all η,η′∈D,

where ≈ in this context must be understood as

a≈b [symbol] a∈{g₁(b),g₂(b), . . . , g₃(b)},

where s is a small number (s=|D|) and the functions g₁, . . . , gₛ are known.

### Example 1

### Integer Coefficients

First we present an example that does not use polynomial rings for the coefficients of the bivariate polynomials of the first private set, but instead integers taken from an integer ring, e.g., integers modulo qᵢ. When using integer rings, instead of polynomial rings, such a choice is provided by D={0, 1, . . ., 2^{b}−1}, R₀={0, 1, . . . , N−1} with addition and multiplication modulo N, Rᵢ={0, 1, . . . , qᵢ−1} with addition and multiplication modulo qᵢ, where qᵢ=N−βᵢ2^{b}, βᵢ∈D, φᵢ and ωᵢ are the identity mapping, χ(x)= [symbol] x [symbol] ₂_{^{b}}, s=6m+2α+3 and gᵢ(b)= [symbol] b+(i−3−m−α−2)N [symbol] ₂_{^{b}}. In this case, s is larger than 1. Although this can be resolved, it would be much preferable if s=1.

### Example 2

### Binary Polynomial Rings for Coefficients

Let R₀, R₁, . . . , Rₘ be rings of polynomials in a variable t of degree less than M with coefficients in Z₂. Addition of polynomials is defined by addition of the coefficients in Z₂, multiplication in R₀ resp. Rᵢ is via modular reduction with a polynomial N(t), resp. Qᵢ(t) of degree M with coefficients in Z₂. Again D={0, 1, . . ., 2^{b}−1}, Ψᵢ(η)=Σⱼ₋^{b-1}ηⱼt^{j}=:η(t), where η=Σⱼ₌₀^{b-1}ηⱼ2^{j} (the same for all i) and φᵢ is the identity map. So we have

$$\begin{matrix}\begin{matrix}{KM}_{η , 𝓁} ( t ) = {〈 {\sum }_{i = 1}^{m} {〈 {\sum }_{k = 0}^{α} {( {f}_{i} ( t ) )}_{k 𝓁} {( η ( t ) )}^{k} 〉}_{{Q}_{i} ( t )} 〉}_{N ( t )} \\ = {\sum }_{i = 1}^{m} {〈 {\sum }_{k = 0}^{α} {( {f}_{i} ( t ) )}_{k 𝓁} {( η ( t ) )}^{k} 〉}_{{Q}_{i} ( t )} \\ = {\sum }_{i = 1}^{m} {\sum }_{k = 0}^{α} {〈 {( {f}_{i} ( t ) )}_{k 𝓁} {( η ( t ) )}^{k} 〉}_{{Q}_{i} ( t )} .\end{matrix} & \\ and \\ {K}_{η} ( {η}^{′} , t ) = {\sum }_{𝓁 = 0}^{α} {〈 {KM}_{n , 𝓁} ( t ) {( {η}^{′} ( t ) )}^{𝓁} 〉}_{N ( t )} . & \end{matrix}$$

Define Δᵢ(t)=Qᵢ(t)+N(t). Any binary polynomial X(t) can be written as

$$\begin{matrix}X ( t ) = P ( t ) N ( t ) + {〈 X ( t ) 〉}_{N ( t )} \\ = {P}_{i} ( t ) {Q}_{i} ( t ) + {〈 X ( t ) 〉}_{{Q}_{i} ( t )} \\ = {P}_{i} ( t ) N ( t ) + {P}_{i} ( t ) {Δ}_{i} ( t ) + {〈 X ( t ) 〉}_{{Q}_{i} ( t )} .\end{matrix}$$

Comparing the first line with the third, it follows that if, and only if, the degree of Pᵢ(t)Δᵢ(t) is less than M, then Pᵢ(t)=P(t) and [symbol] X(t) [symbol] _{Q}_{ᵢ}₍ₜ₎= [symbol] (t) [symbol] _{N(t)}+P(t)Δᵢ(t). It then also holds that [symbol] X(t) [symbol] _{N(t)}= [symbol] X(t) [symbol] _{Q}_{ᵢ}₍ₜ₎+P(t)Δᵢ(t), we shall use the equality in this form as well. For X(t)=(fᵢ(t))ₖₗ(η(t))^{k} with 0≦k≦α, it holds that deg(X(t))≦M−1+α(b−1), so deg(Pᵢ(t))≦α(b−1)−1 and deg(Pᵢ(t)Δᵢ(t))≦α(b−1)−1+deg(Δᵢ(t)). It follows that if deg(Δᵢ(t))≦M−α(b−1) for 1≦i≦m, then

$${KM}_{n , 𝓁} = {\sum }_{i = 1}^{m} {\sum }_{k = 0}^{α} {〈 {( {f}_{i} ( t ) )}_{k 𝓁} {( η ( t ) )}^{k} 〉}_{N ( t )} + {\sum }_{i = 1}^{m} {W}_{i , 𝓁 , η} ( t ) {Δ}_{i} ( t )$$

for some polynomials W_{i,l,η}(t) of degree at most α(b−1)−1, and hence that

$${K}_{η} ( {η}^{′} , t ) = {\sum }_{i = 1}^{m} {\sum }_{k = 0}^{α} {\sum }_{𝓁 = 0}^{α} {〈 {( {f}_{i} ( t ) )}_{k 𝓁} {( η ( t ) )}^{k} {( {η}^{′} ( t ) )}^{𝓁} 〉}_{N ( t )} + {\sum }_{i = 1}^{m} {\sum }_{𝓁 = 0}^{α} {〈 {W}_{i , 𝓁 , η} ( t ) {Δ}_{i} ( t ) {( {η}^{′} ( t ) )}^{𝓁} 〉}_{N ( t )} .$$

Note that if degrees of the Δᵢ(t) satisfy a stronger bound deg(Δᵢ(t))≦M−2α(b−1), then

$${K}_{η} ( {η}^{′} , t ) = {\sum }_{i = 1}^{m} {\sum }_{k = 0}^{α} {\sum }_{𝓁 = 0}^{α} {〈 {( {f}_{i} ( t ) )}_{k 𝓁} {( η ( t ) )}^{k} {( {η}^{′} ( t ) )}^{𝓁} 〉}_{N ( t )} + {\sum }_{i = 1}^{m} {\sum }_{𝓁 = 0}^{α} {W}_{i , 𝓁 , η} ( t ) {Δ}_{i} ( t ) {( {η}^{′} ( t ) )}^{𝓁} .$$

If we also choose all polynomials Δᵢ(t) to have a common factor γ(t), i.e., Δᵢ(t)=βᵢ(t)γ(t), and define

$$κ ( η , {η}^{′} , t ) = {〈 {K}_{η} ( {η}^{′} , t ) 〉}_{γ ( t )} , \\ then$$

$$κ ( η , {η}^{′} , t ) = {\sum }_{k = 0}^{α} {\sum }_{𝓁 = 0}^{α} {〈 {〈 {F}_{k 𝓁} ( t ) {( η ( t ) )}^{k} {( {n}^{′} ( t ) )}^{𝓁} 〉}_{N ( t )} 〉}_{γ ( t )} = κ ( η , {η}^{′} , t ) , \\ with {F}_{k 𝓁} ( t ) = {\sum }_{i = 0}^{m} {( {f}_{i} ( t ) )}_{k 𝓁} .$$

Mapping from R₀ to Z may be done by taking the polynomial coefficient as the bits of the resulting number, which amounts to substituting t=2 in the polynomial:

κ(η,η′)=κ(η,η′,2)

Advantageously, this provides a symmetric function κ(η,η′,t)=κ(η′,η,t), i.e., it ensures that that device η and η′ will derive the same shared key. Unfortunately, these choices provide reduced security, since the function depends only on the sum of the f and not on the individual fᵢ and Qᵢ. So the effect of mixing of the different rings Rᵢ is gone in the final result κ(η,η′,t), even though it is still there in the KM_{η,j}(t).

The reason for the removal of the mixing effect in the final result is the stronger constraint deg(Δᵢ(t))≦M−2α(b−1).

However, the weaker constraint deg(Δᵢ(t))≦M−α(b−1) allows higher security through mixing. This constraint can be used to transform the modulo-N(t) operation in the calculation of Kₙ(η′,t) to a modulo-Qᵢ(t) operation:

$$\begin{matrix}{K}_{η} ( {η}^{′} , t ) = {\sum }_{𝓁 = 0}^{α} {〈 {KM}_{η , 𝓁} ( t ) {( {η}^{′} ( t ) )}^{𝓁} 〉}_{N ( t )} \\ = {\sum }_{𝓁 = 0}^{α} {\sum }_{i = 1}^{m} {\sum }_{k = 0}^{α} {〈 {〈 {( {f}_{k 𝓁} ( t ) )}_{k 𝓁} {( η ( t ) )}^{k} 〉}_{{Q}_{i} ( t )} {( {n}^{′} ( t ) )}^{𝓁} 〉}_{N ( t )} \\ = {\sum }_{𝓁 = 0}^{α} {\sum }_{i = 1}^{m} {\sum }_{k = 0}^{α} [ {〈 {〈 {( {f}_{i} ( t ) )}_{k 𝓁} {( η ( t ) )}^{k} 〉}_{{Q}_{i} ( t )} {( {n}^{′} ( t ) )}^{𝓁} 〉}_{{Q}_{i} ( t )} + {\tilde{W}}_{i , k , 𝓁 , η , {η}^{′}} ( t ) {Δ}_{i} ( t ) ] , \\ = {\sum }_{𝓁 = 0}^{α} {\sum }_{i = 1}^{m} {\sum }_{k = 0}^{α} [ {〈 {( {f}_{i} ( t ) )}_{k 𝓁} {( η ( t ) )}^{k} {( {n}^{′} ( t ) )}^{𝓁} 〉}_{{Q}_{i} ( t )} + {\tilde{W}}_{i , k , 𝓁 , η , {η}^{′}} ( t ) {Δ}_{i} ( t ) ] \\ = {\sum }_{𝓁 = 0}^{α} {\sum }_{i = 1}^{m} {\sum }_{k = 0}^{α} [ {〈 {( {f}_{i} ( t ) )}_{k 𝓁} {( η ( t ) )}^{k} {( {n}^{′} ( t ) )}^{𝓁} 〉}_{{Q}_{i} ( t )} + {\tilde{W}}_{i , k , 𝓁 , η , {η}^{′}} ( t ) {β}_{i} ( t ) γ ( t ) ]\end{matrix}$$

(herein the second term has a degree less than M,)
The first term is symmetric in η and η′, the second term is not, but it is proportional to γ(t), so it drops out when reducing modulo γ(t). Hence κ(η,η′t)= [symbol] Kₙ(η′,t) [symbol] _{γ(t)} is symmetric, and given by

$$κ ( η , {η}^{′} , t ) = {\sum }_{i = 1}^{m} {\sum }_{k = 0}^{α} {\sum }_{𝓁 = 0}^{α} {〈 {〈 {( {f}_{i} ( t ) )}_{k 𝓁} {( η ( t ) )}^{k} {( {η}^{′} ( t ) )}^{𝓁} 〉}_{{Q}_{i} ( t )} 〉}_{γ ( t )} .$$

So for the mixing to occur in the calculation of κ, we need Δᵢ(t)=βᵢ(t)γ(t) with 0≦deg(βᵢ(t))≦M−α(b−1)−deg(γ(t)) for all i, and deg(Δᵢ(t))>M−2α(b−1) for at least one i.

### Example 3

### p-ary Polynomial Rings

Just as in the the binary case, these formula's also work for polynomial rings over Zₚ instead of Z₂.

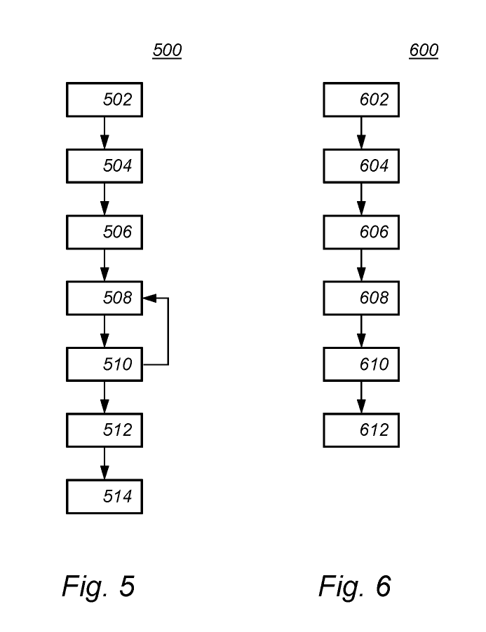

FIG. 5 shows a flowchart illustrating a method 500 for configuring a network device, say first network device 300, for key sharing. Method 500 comprises:

Obtaining 502 in electronic form a public global reduction polynomial 216, N(t), a first private set of bivariate polynomials 212, fᵢ(,), and a second private set of reduction polynomials 214, Qᵢ(t). With each bivariate polynomial in the first set a reduction polynomial of the second set is associated. Step 502 may be part of obtaining key material.

Obtaining 504 in electronic form an identity number 310, A for the network device.

Computing 506 a univariate private key polynomial 228 from the first and second private sets by

Obtaining a set of univariate polynomials by for each particular polynomial of the first private set, substituting 508 the identity number A into said particular polynomial fᵢ(A,) and reducing 510 modulo the reduction polynomial associated with said particular polynomial. Summing 512 the set of univariate polynomials,

Storing 514 the generated univariate private key polynomial 228 and the public global reduction polynomial 216, N(t) at the network device.

FIG. 6 show a flowchart illustrating a method 600 determining a shared key with a second network device 350. Method 600 comprises:

Storing 602 a univariate private key polynomial 312 and a public global reduction polynomial 314, N(t) obtained from a system for configuring a network device for key sharing as described herein.

Storing 604 an identity number 310, A for the first network device.

Obtaining 606 an identity number 355 for the second network device.

Substituting 608 the identity number of the second network device into the univariate private key polynomial and reducing 610 the result of the substituting modulo the public global reduction polynomial N(t).

Deriving 612 the shared key from the result of the reduction modulo the public global reduction polynomial.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. Moreover, a given step may not have finished completely before a next step is started.

A method according to the invention may be executed using software, which comprises instructions for causing a processor system to perform method 500 and/or 600. Software may only include those steps taken by a particular sub-entity of the system. The software may be stored in a suitable storage medium, such as a hard disk, a floppy, a memory etc. The software may be sent as a signal along a wire, or wireless, or using a data network, e.g., the Internet. The software may be made available for download and/or for remote usage on a server.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

t should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for configuring a network device for key sharing, the system comprising:
a key material obtainer for obtaining in electronic forms a public global reduction polynomial (N(t)), a first private set of bivariate polynomials (fᵢ(,)), and a second private set of reduction polynomials (214,Qₜ(t), each bivariate polynomial in the first set being associated with a reduction polynomial of the second set, the first private set of bivariate polynomials (fᵢ(,)) comprising at least two bivariate polynomials and the second private set of reduction polynomials comprising at least two different reduction polynomials,
a network device manager for obtaining in electronic form an identity number for the network device, and
a polynomial manipulation unit for computing a univariate private key polynomial from the first and second private sets by:
mapping the identity number (A) to an identity polynomial (A(t)),
obtaining a set of univariate polynomials by
for each particular polynomial of the first private set, substituting the identity polynomial (A(t)) into said particular polynomial fᵢ(A(t,) and reducing modulo the reduction polynomial associated with said particular polynomial, and
summing the set of univariate polynomials, wherein
the network manager is further configured for electronically storing the generated univariate private key polynomial (228, 236) and the public global reduction polynomial (N(t)) at the network device.

2. The system as in claim 1, further comprising an electronic random number generator, the key material obtainer being configured to perform at least one of the following acts:
generate one or more coefficients of the public global reduction polynomial (N(t)) using the electronic random number generator, and
generate one or more coefficients of a bivariate polynomial (fᵢ(,)) the first private set using the electronic random number generator, and
generate one or more coefficients of a reduction polynomial (Qₜ(t)) in the second private set using the electronic random number generator.

3. The system as in claim 1, wherein the first private set of bivariate polynomials (fᵢ(,)) only comprises symmetric bivariate polynomials.

4. The system as in claim 1, wherein
the first private set of bivariate polynomials (fᵢ(,) comprises at least two different bivariate polynomials, and/or
at least one polynomial of the first private set has a degree of at least two in one of the two variables of said at least one polynomial.

5. The system as in claim 1, wherein
the univariate private key polynomial is represented as a list of coefficients and in a canonical form, and/or
the result of substituting the identity polynomial (A(t) into said particular polynomial (fₜ(A(t)) and reducing modulo the reduction polynomial associated with said particular polynomial is represented as a list of coefficients and in a canonical form before the summing.

6. The system as in claim 1, wherein mapping the identity number (A) to an identity polynomial (A(t)) comprises
converting identity number (A) from a binary number into a number (a=Σⱼ₌₀^{b-1}Aⱼp^{j}) with a base-number (p): different from 2, and
mapping the identity number (A) by assigning the digits (Aⱼ) of the converted identity number as the coefficient of the identity polynomial (A(t)=Σⱼ₌₀^{b-1}Aⱼt^{j}).

7. The system as in claim 1, wherein mapping the identity number (A) to an identity polynomial comprises
hashing the identity number and converting the result of the hashing to at least part of the identity polynomial.

8. The system as in claim 1, wherein the key material obtainer is configured to generate a common polynomial (γ(c), and generate the reduction polynomials (Qₜ(t) as the difference (Qₜ(t)=N(t)−βₜ(t)γ(t)) between the public global reduction polynomial (N(t) and a multiple of the common polynomial.

9. The system as in claim 8, wherein the multiple of the common polynomial has degree less than or equal to M−a(b−1), wherein M is the degree of the public global reduction polynomial (N(t), α is the highest degree of a polynomial in the first private set of bivariate polynomials, and b is the number of bits of the identity number.

10. The system as in claim 8, wherein at least one multiple of the common polynomial has degree higher than M−2a(b−1).

11. A first network device configured to determine a shared key with a second network device, the first network device comprising
an electronic storage storing a univariate private key polynomial, and a public global reduction polynomial (N(t) obtained from a system for configuring a network device for key sharing, the storage further storing an identity number for the first network device,
a communication unit for obtaining an identity number of the second network device, the second network device being different from the first network device,
a polynomial manipulation unit for
mapping the identity number of the second network device to an identity polynomial, substituting the identity polynomial into the univariate private key polynomial and reducing the result of the substituting modulo the public global reduction polynomial (N(t)),
a key derivation device for deriving the shared key from the result of the reduction modulo the public global reduction polynomial.

12. The first network device as in claim 11, wherein
the electronic storage stores a univariate private key polynomial, a public global reduction polynomial (N(t)), and a common polynomial (γ(t)), obtained from a system for configuring a network device for key sharing,
a polynomial manipulation unit further configured for
further reducing the result of the reducing modulo the public global reduction polynomial (N(t) modulo the common polynomial (γ(t).

13. (canceled)

14. A method for configuring a network device for key sharing, the method comprising:
obtaining in electronic form a public global reduction polynomial (N(t)), a first private set of bivariate polynomials (fₜ(,), and a second private set of reduction polynomials (214, Qₜ(t), with each bivariate polynomial in the first set a reduction polynomial of the second set being associated, the first private set of bivariate polynomials (fₜ(,)) comprises at least two bivariate polynomials and the second private set of reduction polynomials comprises at least two different reduction polynomials,
obtaining in electronic form an identity number for the network device,
computing, a univariate private key polynomial from the first and second private sets by
mapping the identity number (A) to an identity polynomial (A(t)),
obtaining a set of univariate polynomials by
for each particular polynomial of the first private set, substituting the identity polynomial (A(t) into said particular polynomial fₜ(A(t),) and reducing modulo the reduction polynomial associated with said particular polynomial, and
summing the set of univariate polynomials,
storing the generated univariate private key polynomial and the public global reduction polynomial (N(t)) at the network device.

15. A method determining a shared key with a second network device, the method comprising
storing a univariate private key polynomial and a public global reduction polynomial (N(t)) obtained from a system for configuring a network device for key sharing,
storing an identity number for the first network device,
obtaining an identity number of the second network device,
mapping the identity number (A) of the second network device to an identity polynomial (A(t))
substituting the identity polynomial into the univariate private polynomial and reducing the result of the substituting modulo the public global reduction polynomial (N(t)),
deriving the shared key from the result of the reduction modulo the public global reduction polynomial.

16. (canceled)

17. (canceled)

18. A non-transitory computer-readable medium having one or more executable instructions stored thereon, which when executed by a processor, cause the processor to perform a method for determining a shared key with a second network device, the method comprising:
storing a univariate private key polynomial and a public global reduction polynomial (N(t)) obtained from a system for configuring a network device for key sharing, storing an identity number for the first network device,
obtaining an identity number of the second network device,
mapping the identity number (A) of the second network device to an identity polynomial (A(t))
substituting the identity polynomial into the univariate private polynomial and reducing the result of the substituting modulo the public global reduction polynomial (N(t)),
deriving the shared key from the result of the reduction modulo the public global reduction polynomial.
